(19) United States
(12) Patent Application Publication
(10) Pub. No.: US 2013/0041917 A1
(43) Pub. Date: Feb. 14, 2013

(54) Method of Locating and Retrieving a Motor Vehicle with a Portable Computing Device

(71) Applicant: Brenton WOOLWORTH, Laguna Hills, CA (US)

(72) Inventor: Brenton WOOLWORTH, Laguna Hills, CA (US)

(21) Appl. No.: 13/571,243

(22) Filed: Aug. 9, 2012

Related U.S. Application Data
(60) Provisional application No. 61/521,622, filed on Aug. 9, 2011.

(51) Int. Cl. G06F 17/30

(52) U.S. Cl. 707/769; 707/E17.014

(57) ABSTRACT

A method of locating and retrieving a motor vehicle with a portable computing device is an electronic application which includes a guest account, a database, and a plurality of user accounts. Each of the plurality of user accounts includes a registered location code. A customer can send an electronic message to the database through a guest portable electronic computing device where the customer is treated as the guest account. The electronic message includes a specific location code and a vehicle identifier code. Then the specific location code is matched with the registered location code and a corresponding user account is identified. Then the electronic message is forwarded to a plurality of active communication mediums in the corresponding user account and is displayed through a user portable electronic computing device. An employee with the corresponding user account retrieves the electronic message and retrieves the customer's motor vehicle.

The current application claims a priority to the U.S. Provisional Patent application Ser. No. 61/521,622 filed on Aug. 9, 2011.

### FIELD OF THE INVENTION

The present invention relates generally to a method of location. More specifically, the present invention is a method of locating and retrieving one's motor vehicle from valet parking using a mobile application, a central hosted database, and a coded ticket.

### BACKGROUND OF THE INVENTION

Valet parking is a system of parking offered at various establishments where a customer's car is parked by another individual called a valet. This service is often offered at a fee or free of charge as a convenience to customers. Without valet parking, customers can spend a great deal of time searching for an open parking space nearby. However, although valet parking can eliminate time wasted searching for parking before entering an establishment, customers are at times forced to waste time waiting for their motor vehicle to be retrieved upon leaving the establishment. It is therefore an object of the present invention to provide a method and system where the customer can use a mobile application ahead of departure time for the retrieval of their motor vehicle from valet parking, and have it ready by the time they arrive outside.

### BRIEF DESCRIPTION OF THE DRAWINGS

FIG. 1 is a flow chart illustrating the overall process that allows the present invention to retrieve a motor vehicle through a portable computing device

FIG. 2 is a flow chart illustrating the overall process that allows the present invention to send an electronic message to a corresponding user account.

FIG. 3 is a flow chart illustrating the overall process that allows the present invention to manage a plurality of registered phone numbers.

FIG. 4 is a flow chart illustrating the overall process that allows the present invention to send an electronic alert message to a guest account.

FIG. 5 is a system view of the present invention.

### DETAILED DESCRIPTION OF THE INVENTION

All illustrations of the drawings are for the purpose of describing selected versions of the present invention and are not intended to limit the scope of the present invention.

The present invention provides a mobile application that efficiently connects a customer with a valet parking attendant so that the customer does not have to wait for his or her motor vehicle wasting valuable time. The present invention protects both the customer and the valet parking attendant by never allowing either party to obtain each other's personal information.

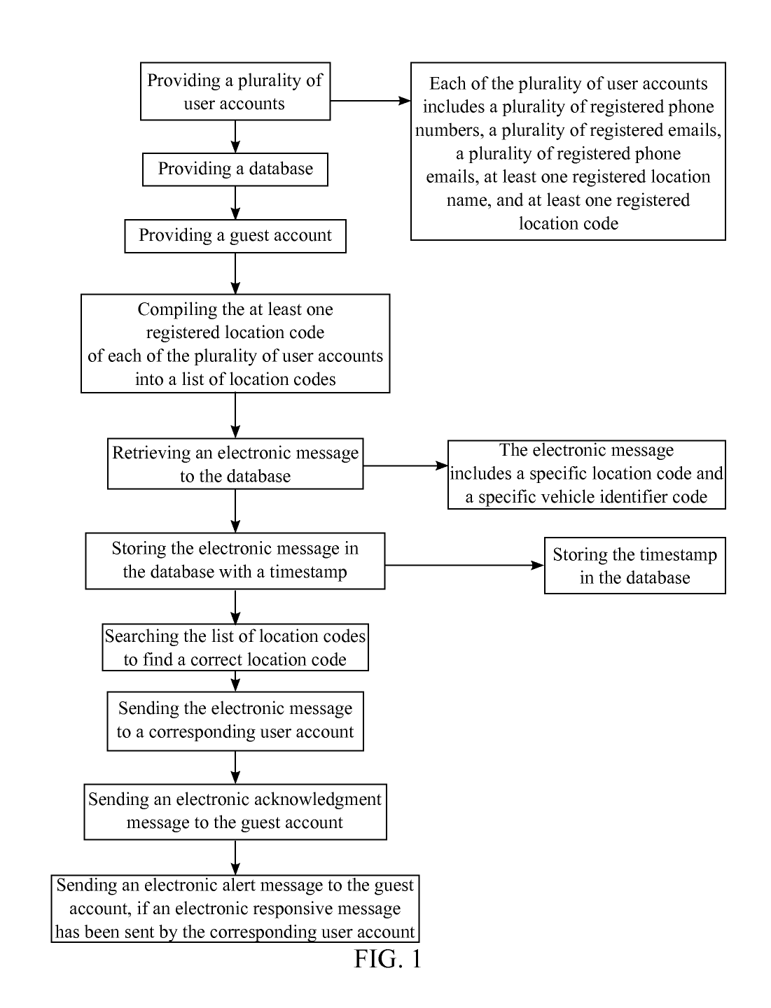

In one embodiment of the invention, the owner of a particular company, who requires the service of the present invention, needs to create a user account within a database 4. In reference to FIG. 1, the user account comprises a plurality of registered phone numbers, a plurality of registered phone emails, a plurality of registered emails, at least one registered location name, and at least one registered location code. The owner of the user account enters a plurality of phone numbers, a plurality of phone emails, a plurality of emails, and at least one location name during a registration process. The registration process can be done through a computing device and all of the entered information is saved into the database 4. Then the plurality of phone numbers, the plurality of phone emails, the plurality of emails, and the at least one location name become the plurality of registered phone numbers, the plurality of registered phone emails, the plurality of registered emails, and the at least one registered location name. The user account also receives at least one registered location code referenced to the at least one registered location name. If the user account has additional registered locations, each of the additional registered location is given uniquely different location code. For example, if a specific user account has a first registered location name and a second registered location name, the first registered location name and the second location name correspond with two different location codes. The present invention enables different companies to create their own user account within the database 4 where the database 4 comprises a plurality of user accounts. Since each of the plurality of user accounts has the at least one registered location code, the software application in the present invention is able to individually identify each of the plurality of user account and the at least one registered location name. The software application also compiles the at least one registered location code of each of the plurality of user accounts into a list of location codes, and the list of location codes is stored in the database 4.

According to an embodiment of the invention, the customer is given a valet ticket when the customer arrives to an establishment. The valet ticket may include a ticket phone number, a specific location code, and a specific vehicle identifier code. The ticket phone number includes a telephone number which functions as a central gateway 3 between the customer and the database 4. The ticket phone number stays same for all of the valet tickets creating an easily remembered customer friendly system. If the owners want to obtain customize ticket phone numbers for their valet tickets, the valet ticket can be customized according to the requirements. Each of the valet ticket functions as a single transaction within the present invention. The owner of each of the plurality of user accounts can obtain any number of valet tickets so that multiple transactions can be implemented within the present invention. When the customer needs to have his or her motor vehicle brought up, the customer is automatically treated as a guest account by the software application. The guest accounts do not register or stored within the database 4. Since the guest accounts don't have go through any kind of registration process, the present invention allows a time efficient system for the customers.

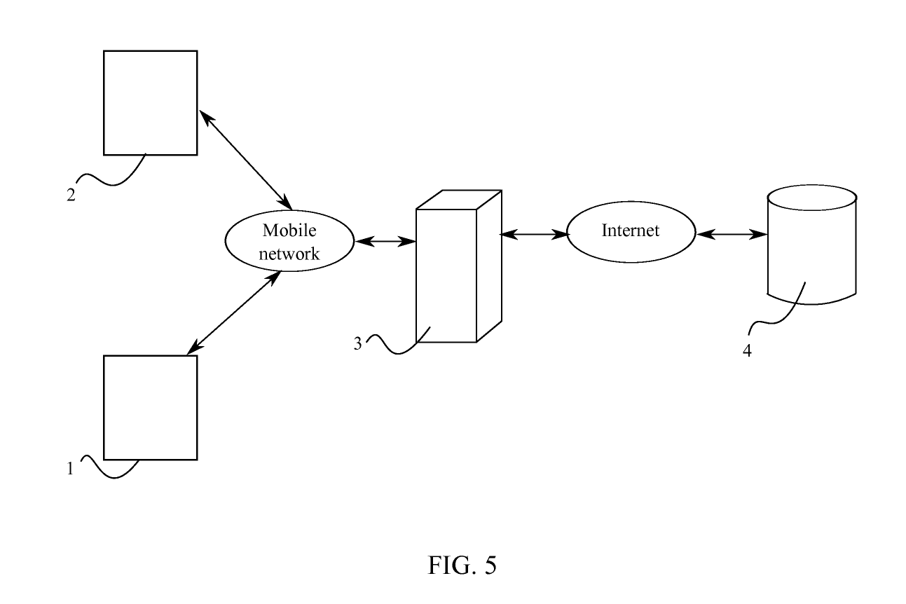

In a preferred embodiment of the invention, an electronic message is sent to the ticket phone number from the guest account. In reference to FIG. 1, the electronic message can be sent as an electronic mail or a short message service through a guest portable electronic computing device 1. The electronic message includes the specific location code and the specific vehicle identifier code which can be obtained from the valet ticket. The specific location code and the specific vehicle identifier code are displayed as a one set of number in the valet ticket, but the software application is programmed to differentiate the specific location code apart from the specific vehicle identifier code once the electronic message receives to the database 4. In reference to FIG. 5, the central gateway 3 retrieves the electronic message through a mobile network, and sends the electronic message to the database 4 through a worldwide network. The worldwide network is also recognized as the internet. Then the specific location code and the specific vehicle identifier code in the electronic message are saved in the database 4 with a timestamp. The timestamp records the date and time of the electronic message in the database 4. Upon request, each of the plurality of user accounts can retrieve a copy of the timestamp and a copy of the electronic message. The software application then searches through the list of location codes until a correct location code is selected from the list of location codes, where the correct location code numerically matches with the specific location code. Since each of the plurality of user accounts is stored in the database 4 with the at least one registered location code, the software application selects a corresponding user account where the corresponding user account includes the correct location code. Then the software application identifies the at least one registered location name in reference with the correct location code.

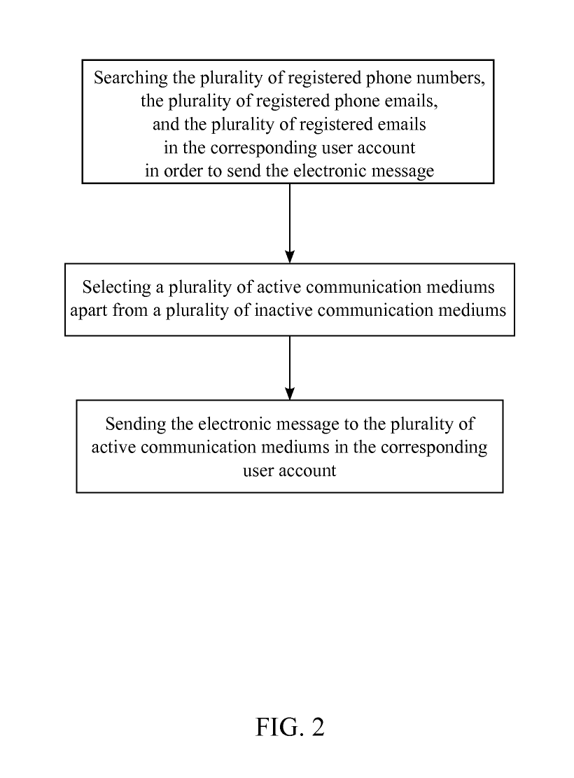

In reference to FIG. 2, the database 4 then forwards the electronic message to the corresponding user account through the central gateway 3 by using the worldwide network and the mobile network. At the same time, an electronic acknowledgment message may be sent to the guest account from the software application acknowledging that the electronic message has been received to the database 4. Since the specific location code and the specific vehicle identifier code are stored in the database 4, the same valet ticket can't be reused unless the specific vehicle identifier code is sequentially returns. For example, if the specific vehicle identifier code consists with four digits, the specific vehicle identifier is reused every 10,000 times. The plurality of registered phone numbers, the plurality of registered phone emails, and the plurality of registered emails in the corresponding user account includes a plurality of active communication mediums and a plurality of inactive communication mediums. When the electronic message is forwarded to the matching user account, the software application searches for the plurality of active communication mediums in the corresponding user account and forwards the electronic message only to the plurality of active communication mediums. Once the electronic message is forwarded, the electronic message can be displayed to a valet parking attendant though a user portable electronic computing device 2. The user portable electronic computing device 2 can be a mobile smart phone, a desktop computer, or any other type of computing device. Since the electronic message has the specific location code and the specific vehicle identifier code, the valet parking attendant can match the specific location code and the specific vehicle identifier code with the correct motor vehicle and bring the correct motor vehicle to the customer as he or she comes out of the establishment. Due to the efficiency of the present invention, the customers don't have to wait for a long time to retrieve their motor vehicle.

A preferred example of the present invention is as follows:
1. The customer sends the electronic message to 555-555-5555 and includes 100560 in the electronic message.
2. The database 4 recognizes 100 as being the specific location code, because the setting may be set to recognize the first three digits as the specific location code.
3. The database 4 selects the user account which has the registered location 100.
4. The database 4 recognizes that the location 100 includes three registered phone numbers that are 564-535-8686, 564-525-8764, and 564-786-4561. Out of the three registered phone numbers, only 564-525-8764 is active.
5. The database 4 forwards the electronic message to 564-525-8764, which is the only active registered phone number for location 100.
6. The database 4 then sends the electronic acknowledgment message to the customer acknowledging that the database 4 received the electronic message.

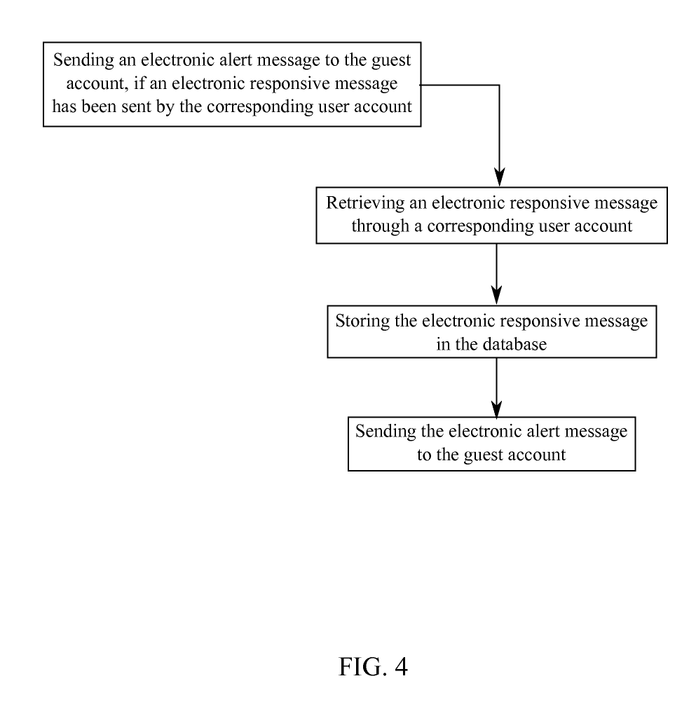

According to the embodiment of the invention show in FIG. 4, if the valet parking attendant unable to retrieves the correct motor vehicle to the customer or wants to send any other message regarding the customer's motor vehicle, the valet parking attendant can send an electronic responsive message to the database 4 through the user portable electronic computing device 2. The electronic responsive message can be a user coded message or a brief written text message. If the database 4 retrieves the brief written text message from the corresponding user account, the software application sends an electronic alert message to the guest account where the electronic alert message includes the brief written text message. The customer can view the electronic alert message through the guest portable electronic computing device 1. The brief written text message also gets stored in the database 4 by the software application. For example, when the valet parking attendant sends a text message, where the text message body includes “you have taken the key, therefore I can't retrieve your motor vehicle”, the text message is then forwarded to the customer. If the database 4 retrieves the user coded message from the corresponding user account, the software application stores the user coded message in the database 4. The software application then searches through a list of coded messages, where the list of coded messages comprises a plurality of user coded messages, and selects a specific coded message from the list of coded messages. The specific coded message matches with the user coded message where the specific coded message corresponds to a unique description. Each of the plurality of user accounts is given the list of coded messages so that the different unique descriptions within the list of coded messages are cleared to the employees. The software application then attaches the unique description into the electronic alert message and sends the electronic alert message to the guest account. Then the customer can view the electronic alert message through the guest portable electronic computing device 2. For example, when the valet parking attendant sends the user coded message, where the user coded message body includes “#123”, the user coded message is stored in the database 4. Then the software application recognizes the specific coded message which is “#123” and the unique description which is “your motor vehicle has arrived” with reference to the user coded message.

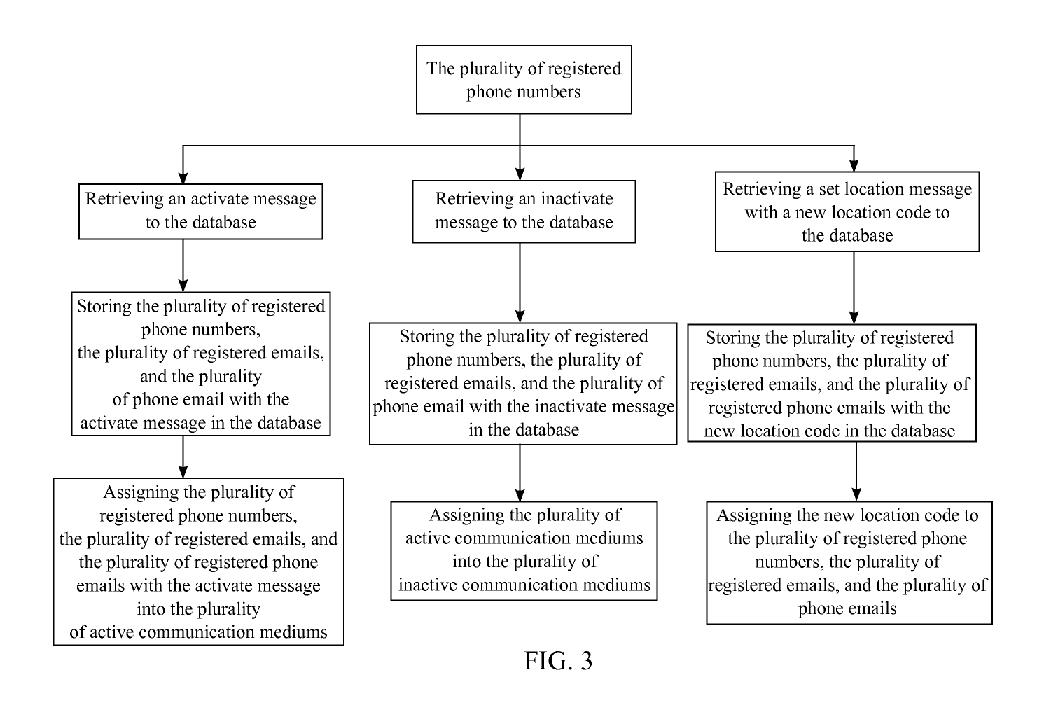

According to the embodiment of the invention shown in FIG. 3, when an activate message retrieves to the database 4 from the plurality of registered phone numbers, the plurality of registered phone emails, or the plurality of registered emails, the activate message with the plurality of registered phone numbers, the plurality of registered phone emails, and the plurality of registered emails are stored in the database 4. The activate message may include information instructing the control software to activate the plurality of registered phone numbers, the plurality of registered phone emails, and the plurality of registered emails. In the preferred embodiment, the phrase “turn system on” is sent as the activate message but it is not limited only to the phrase “turn system on”. Then the plurality of registered phone numbers, the plurality of registered phone emails, and the plurality of registered emails with the activate message are assigned as the plurality of active communication mediums. When an inactive message retrieves to the database 4 from the plurality of registered phone numbers, the plurality of registered phone emails, or the plurality of registered emails, the inactive message with the plurality of registered phone numbers, the plurality of registered phone emails, and the plurality of registered emails are stored in the database 4. The inactivate message includes information instructing the control software to inactivate the plurality of registered phone numbers, the plurality of registered phone emails, and the plurality of registered emails. In the preferred embodiment, the phrase “turn system off” is sent as the inactivate message but it is not limited only to the phrase “turn system off”. Then the plurality of active communication mediums with the inactivate message is assigned as the plurality of inactive communication mediums. The plurality of active communication mediums and the plurality of inactive communication mediums selectively allow the owners to control the receiving electronic messages from the software application. For example, an employee can send the inactivate message where the inactivate message body contains the text “turn system off' when the employee gets off from his or her shift. Then the employee does not receive the electronic messages from the software application so that the employee gets to enjoy his or her leisure time without any distraction.

The owner of each of the plurality of user accounts may have to change locations out of convenience. In this particular situation, the owner of each of the plurality of user accounts is given a new location code. Then owner of each of the plurality of user accounts can change the at least one registered location code with the new location code. Each of the plurality of user accounts can change the at least one registered location code with a set location message where the set location message includes the new location code. When the-set location message retrieves to the database 4, the control software identifies the plurality of registered phone numbers, the plurality of registered phone emails, and the plurality of registered emails with reference to the at least one registered location code. Then the control software replaces the at least one registered location code with the new location code. The new location code is then stored in the list of location codes with reference to the plurality of registered phone numbers, the plurality of registered phone emails, and the plurality of registered emails. After the new location code is stored within the present invention, any of the electronic messages retrieve for the prior at least one registered location code may get rerouted to the new location code by the software application.

The plurality of user accounts and all of the entered information in the database 4 are monitored by an administrative team. The present invention allows the successful integration of the electronic mail and the short message service between the customer and the valet parking attendant providing a quicker service to the customer while improving the efficiency of the valet parking system. The present invention can also be implemented in car dealerships, service centers, mechanical repair shops, and collision centers to improve customer service and to improve productivity.

Although the invention has been explained in relation to its preferred embodiment, it is to be understood that many other possible modifications and variations can be made without departing from the spirit and scope of the invention as hereinafter claimed.

What is claimed is:

1. A system of obtaining a motor vehicle from valet parking comprises,
a guest portable electronic computing device;
a user portable electronic computing device;
a central gateway;
a database;
the guest portable electronic computing device being communicatively coupled with the database through the central gateway; and
the user portable electronic computing device being communicatively coupled with the database through the central gateway.

2. The system of obtaining a motor vehicle from valet parking as claimed in claim 1 comprises,
the guest portable electronic computing device being communicatively coupled with the central gateway through a mobile network; and
the central gateway being communicatively coupled with the database through a worldwide network, wherein the worldwide network is recognized as internet.

3. The system of obtaining a motor vehicle from valet parking as claimed in claim 1 comprises,
the user portable electronic computing device being communicatively coupled with the central gateway through the mobile network.

4. A method of obtaining a motor vehicle from valet parking with a portable computing device by executing computer-executable instructions stored on a non-transitory computer-readable medium, the method comprises the steps of:
providing a plurality of user accounts, wherein each of the plurality of user accounts includes a plurality of registered phone numbers, the plurality of registered phone emails, a plurality of registered emails, at least one registered location name, and at least one registered location code;
providing a database, wherein the plurality of user accounts is stored in the database;
providing a guest account, wherein the guest account is accessed through a guest portable electronic computing device;
compiling the at least one registered location code of each of the plurality of user accounts into a list of location codes;
simultaneously retrieving a specific location code and a specific vehicle identifier code as an electronic message from the guest account;
storing the electronic message in the database with a timestamp;
searching the list of location codes in order to find a correct location code numerically matching the specific location code;
sending the electronic message to a corresponding user account with the correct location code, wherein the electronic message is displayed through a user portable electronic computing device;
sending an electronic acknowledgment message to the guest account, if the electronic message has been sent to the corresponding user account; and
sending an electronic alert message to the guest account, if an electronic responsive message has been sent by the corresponding user account.

5. The method of obtaining a motor vehicle from valet parking with a portable computing device by executing computer-executable instructions stored on a non-transitory computer-readable medium, the method as claimed in claim 4 comprises the steps of:
retrieving the specific location code and the specific vehicle identifier code through the guest portable electronic computing device; and
storing the timestamp for the electronic message in the database, wherein the timestamp records the date and the time of the electronic message.

6. The method of obtaining a motor vehicle from valet parking with a portable computing device by executing computer-executable instructions stored on a non-transitory computer-readable medium, the method as claimed in claim 4 comprises the steps of:
searching for the plurality of registered phone numbers, the plurality of registered phone emails, and the plurality of registered emails in the corresponding user account in order to send the electronic message;
selecting a plurality of active communication mediums apart from a plurality of inactive communication mediums, wherein the plurality of registered phone numbers, the plurality of registered phone emails, and the plurality of registered emails comprises the plurality of active communication mediums and the plurality of inactive communication mediums; and
sending the electronic message to the plurality of active communication mediums in the corresponding user account.

7. The method of obtaining a motor vehicle from valet parking with a portable computing device by executing computer-executable instructions stored on a non-transitory computer-readable medium, the method as claimed in claim 6 comprises the steps of:
retrieving an activate message to the database from the plurality of registered phone numbers, the plurality of registered phone emails, or the plurality of registered emails;
storing the plurality of registered phone numbers, the plurality of registered phone emails, and the plurality of registered emails with the activate message in the database; and
assigning plurality of registered phone numbers, the plurality of registered phone emails, and the plurality of registered emails with the activated message as the plurality of active communication mediums.

8. The method of obtaining a motor vehicle from valet parking with a portable computing device by executing computer-executable instructions stored on a non-transitory computer-readable medium, the method as claimed in claim 6 comprises the steps of:
retrieving an inactivate message to the database from the plurality of active phone numbers, the plurality of registered phone emails, or the plurality of registered emails;
storing the plurality of registered phone numbers, the plurality of registered phone emails, and the plurality of registered emails with the inactivate message in the database; and
assigning the plurality of active communication mediums with the inactivate message into the plurality of inactive communication mediums.

9. The method of obtaining a motor vehicle from valet parking with a portable computing device by executing computer-executable instructions stored on a non-transitory computer-readable medium, the method as claimed in claim 6 comprises the steps of:
retrieving a set location message with a new location code to the database from the plurality of registered phone numbers, the plurality of registered phone emails, or the plurality of registered emails;
storing the plurality of registered phone numbers, the plurality of registered phone emails, and the plurality of registered emails with the new location code in the database; and
assigning the new location code to the plurality of registered phone numbers, the plurality of registered phone emails, and the plurality of registered emails.

10. The method of obtaining a motor vehicle from valet parking with a portable computing device by executing computer-executable instructions stored on a non-transitory computer-readable medium, the method as claimed in claim 4 comprises the steps of:
retrieving the electronic responsive message through the corresponding user account;
storing the electronic responsive message in the database; and
sending the electronic alert message to the guest account, wherein the electronic alert message is displayed through the guest portable electronic computing device.
